(19) United States
(12) Patent Application Publication
(10) Pub. No.: US 2025/0094815 A1
(43) Pub. Date: Mar. 20, 2025

(54) GENERATING CONTENT LABELS FOR INTEGRATION WITHIN GRAPHICAL USER INTERFACES

(71) Applicant: Dropbox, Inc., San Francisco, CA (US)

(72) Inventors: Tony Xu, Redmond, WA (US); Sean Stephens, Summer, WA (US)

(21) Appl. No.: 18/470,124

(22) Filed: Sep. 19, 2023

(51) Int. Cl. G06N 3/09

(52) U.S. Cl. CPC G06N 3/09

(57) ABSTRACT

The present disclosure relates to systems, non-transitory computer-readable media, and methods for generating and providing customized content labels as elements for seamless integration within a graphical interface. For instance, the disclosed systems provide generative options utilizing contextual data to more effectively incorporate a content label (textual and/or visual) based on the surrounding graphical elements, the functionality of the label within the interface, and the purpose of the label or interface. In this way, the disclosed systems generate contextual labels with appropriate textual content and that are appropriately sized, styled, and positioned based on their relevance within the context of the graphical interface.

### BACKGROUND

Recent years have seen significant improvements in computer hardware and software platforms for generating, modifying, and sharing digital content across a variety of graphical interfaces. For example, the proliferation of computing devices and expanding network capabilities has led to widespread generation and dissemination of digital content utilizing graphical user interfaces that contain various type of content labels. Indeed, content labels play an important role in guiding users, providing clarity, and facilitating interaction within graphical interfaces. Despite these advances, however, existing content creation and presentation computing systems often suffer from technological shortcomings that result in a number of deficiencies particularly in regard to providing functional and flexible content labels within graphical user interfaces.

As just suggested, when providing content labels, some existing systems lack efficient functionality. For example, the ambiguous language, organizational structure, insufficient context, inadequate descriptions, and/or inconsistent terminology of existing systems make it difficult for user devices to locate desired content or functionality. To illustrate, the inconsistent terminology of digital content labels (e.g., inconsistent wording/phrasing for similar functions across different parts of the GUI) within existing systems often makes label interpretation difficult for end-users and hinders user device navigation within a website or graphical interface. What is more, many existing systems use a complex organizational structure for digital content labels that impacts the efficiency and effectiveness of the graphical interface. In addition, the unclear language and presentation of content labels within many existing systems buries important features and forces end-users to spend more time navigating the graphical interfaces. Further, existing systems often lack useful aesthetic signals regarding content labels, making it challenging for users to distinguish between different applications or platforms based on visual cues. In addition, the cluttered interfaces of many graphical interfaces combined with the poor formatting of existing content labels often make it difficult to distinguish labels from other content, affecting both readability and navigation to hinder overall device performance.

As just suggested, some existing digital content systems are not flexible. Along these lines, existing systems often utilize a fixed structure and layout that provides limited modification and/or customization options for content labels. For example, in existing systems, changes to the content label hierarchy or content label graphical presentation often requires significant redevelopment, making it difficult to accommodate evolving system user device needs, preferences or changes. Often the suboptimal architecture of existing systems leads to incorrect, inconsistent, or inconvenient placement of content labels. Furthermore, often ineffective use of content labels within existing systems creates compatibility and integration challenges when integrating with other systems. For example, due to inconsistent styling, existing systems can introduce errors or inconsistencies that can propagate through the integrated systems providing bottlenecks during integration tasks that increase development time.

For example, existing content presentation systems often adhere to particular content label presentation schemes that are rigidly structured according to the devices, platforms, or application. In some cases, the rigid nature of existing content label presentation schemes results in errors or broken content when providing digital content labels for display, especially in cases where a recipient device is not compatible with a particular type of content label included within the digital document, due to device constraints, network constraints, and/or other factors. For example, some systems provide content labels that do not adapt to different screen sizes or devices which leads to awkward device interactions and forces the device to zoom or scroll excessively to access the digital content.

The above-mentioned disadvantages are a result of problems that arise within existing technological environments within which programs and applications are developed. In particular, current programs and applications include large amounts of functionality, menus, and other items that are exposed on a client device via a graphical user interface. Existing development environments often require content labels to be added on a label-by-label basis and be added by multiple different teams or developers. The result of these environments is a lack of flexibility when it comes to creating an original set of accurate labels as well as when there are any updates to an application, it is often inefficient to update corresponding content labels or results in old and inaccurate labels being used.

These, along with additional problems and issues, exist with regard to existing systems.

### SUMMARY

One or more embodiments described herein provide benefits and/or solve one or more problems in the art with systems, methods, and non-transitory computer readable storage media that generate and provide customized content labels as elements for seamless integration within a graphical interface. For instance, the disclosed systems provide generative options utilizing contextual data to more effectively incorporate a content label (including textual and/or visual content) based on the purpose of the label or interface, the functionality of the label within the interface, and the surrounding graphical elements. For example, the disclosed systems generate labels based on contextual data, position and align the labels to provide a responsive design where the labels and elements adjust to different screen sizes and orientations to ensure useability. Further, the disclosed systems utilize label generation rules to provide consistency in labelling and create cohesive and functional graphical interfaces. In this way, the disclosed systems generate contextual labels with appropriate textual content and that are also appropriately sized, styled, and positioned based on their relevance within the context of the graphical interface.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment within which a content label system can operate in accordance with one or more embodiments;

FIG. 2 illustrates an example of a content label system generating a content label in accordance with one or more embodiments;

FIG. 3 illustrates an example graphical interface for providing a label generation prompt to generate a content label in accordance with one or more embodiments;

FIG. 4 illustrates an example graphical interface for providing contextual label data to generate a content label in accordance with one or more embodiments;

FIG. 5 illustrates an example graphical interface for providing label generation rules to generate a content label in accordance with one or more embodiments;

FIG. 6 illustrates examples of a content label system training a label generator neural network in accordance with one or more embodiments;

FIG. 7 illustrates examples of a content label system training a label generator neural network in accordance with one or more embodiments;

FIG. 8 illustrates an example of a content label system modifying a content label for a graphical interface in accordance with one or more embodiments;

FIG. 9 illustrates a flowchart of a series of acts for generating a content label in accordance with one or more embodiments;

FIG. 10 illustrates a block diagram of an exemplary computing device in accordance with one or more embodiments; and

FIG. 11 illustrates a networking environment of a content label system in accordance with one or more embodiments.

### DETAILED DESCRIPTION

This disclosure describes embodiments of a content label system that generates customized content labels as elements for coordinative integration within a graphical interface. For instance, the disclosed systems provide generative options utilizing contextual data to more effectively incorporate a content label based on the surrounding graphical elements, the functionality of the label within the interface, and the purpose of the label or interface. For example, the disclosed systems generate labels based on a content hierarchy profile that defines a structured representation of different content categories associated with content labels for the graphical interface. Further, the disclosed systems utilize contextual data to position and align the labels to provide a responsive content label system where the labels and elements adjust to different device constraints to improve useability of the interface. In addition, the disclosed systems utilize label generation rules to create cohesive and functional graphical interfaces by providing consistency in labelling within the graphical interface. In this way, the disclosed systems generate contextual labels with suitable textual content and that are appropriately termed, sized, styled, and positioned based on their relevance within the context of the graphical interface.

As just mentioned, in one or more embodiments, the content label system generates a content label contextual label data based on the context of how and where the content label is to be placed within a graphical interface. For example, the content label system utilizes contextual information to coordinate a label location, determine border configuration of the label, determine a label category within the graphical interface, determine a graphical interface element size, determine a character font, and/or determine other context within a graphical interface. In certain embodiments, the content label system utilizes a content hierarchy profile defining a structured representation of different content categories associated with content labels for the graphical interface.

In certain embodiments, the content label system utilizes label generation rules to define parameters for generating labels. For example, the content label system generates labels based on rules that incorporate design requirements including branding, user experience, visual identity, and functional needs. In certain embodiments, the content label system generates the labels based on the target audience and the constraints associated with predefined rules and variables. In this way, the content label system streamlines the process of generating labels for different sections and functionalities within specific graphical systems based on requirements associated with a visual presentation of the graphical interface for an organization. In some cases the content label system generates labels that can be localized for different languages and use-cases such as accounting for longer text translations or using symbols that are universally understood.

In certain embodiments, the content label system generates a label based on a label generation prompt. For example, the label generation prompt can include a natural language text string indicating the purpose, context, and/or constraints for the content label. For example, the label generation prompt can include contextual label data, a set of label generation rules, and a label generation prompt for generating a content label corresponding to an interface element within a graphical interface. To illustrate, the label generation prompt instructs the model to generate a label for a particular graphical interface element or for a particular purpose within a graphical interface. The text prompt can also include limiters that define constraints or parameters for the label (e.g., “with a length of no more than 20 characters” or “using informal language”).

In some cases, the content label system utilizes one or more neural networks to determine the content label from the label generation prompt. For example, the content label system can utilize a large language model designed for natural language processing tasks to capture contextual relationships within the label generation prompt to generate the content label. In one or more embodiments, the neural network is pre-trained on a large corpora of text data and fine-tuned on a smaller dataset. To illustrate, the content label system generates the content label utilizing a neural network based on historical training data and utilizes a measure of loss between training data and the content label. In some cases, the content label system generates an additional content label based on the content label and historical content label generation requests and provides the additional content label for presentation within the graphical interface.

Embodiments of the content label system can provide many technological advantages and benefits over existing systems and methods. In particular, because of the above-described problems that arise in existing systems, the content label system can improve flexibility and functionality relative compared to these existing systems. Specifically, in one or more embodiments, the content label system can improve system flexibility when generating content labels by providing a graphical interface that accepts a multifaceted label generation instruction to inject functionality, personality, and creativity into a content label associated with a graphical interface. The content label system can also utilize a variety of content label presentation schemes that improve the flexibility of the content labels for use with different devices and within different system environments. For example, the content label system can generate content labels that incorporate aesthetic signals, which make it easier for to distinguish between different applications or platforms based on visual cues. Further, the content label system can flexibly accommodate changes to the content label based on a content label hierarchy and rules for a graphical interface to provide a seamless integration of the content label into an environment, program, and/or application. Additionally, the content label system can seamlessly integrate changes to a content label (or a set of content labels) to accommodate evolving system user device needs, preferences, and/or changes.

What is more, the content label system can provide improved efficiency over existing systems by utilizing a neural network to generate label content based on a label generation instruction, contextual label data, and label generation rules. In contrast to the inconsistent terminology and representations of existing digital content labels that often hinders user device navigation within a website or graphical interface (e.g., by making label interpretation difficult), the content label system utilizes a neural network to provide consistent content labels and an efficient navigation interface. For example, the content label system generates content labels with consistent wording, phrasing, and presentation for similar functions across different parts of the graphical interface. In addition, by using a content label hierarchy and label generation rules, the content label system can provide improved scalability for content labels across associated graphical interfaces (e.g., a website or multiple associated interfaces) to accommodate evolving system needs. Indeed, the content label system can ensure a consistent architecture that supports compatibility and efficient technical integration with other systems.

Along these lines, the content label system can implement an effective hierarchy for a graphical interface by generating content labels as graphical components that can be rearranged or combined in different ways. In addition, the content label system provides a system for efficiently adjusting the content labels within the hierarchy to meet changing system needs and programs are updated. Further, the content label system can generate content labels based on different constraints for different device and organizational needs. For example, the content label system can utilize contextual data to create content labels with formatting to improve readability and navigation. Additionally, the content label system can utilize label generation rules to provide a consistent tone across a set of graphical interfaces. By providing options to intelligently create content labels for display within a graphical interface, the content label system can circumvent the issues of prior systems that cause graphical interfaces to be displayed incorrectly (e.g., with broken links, mangled formatting, fragmented content) and/or with inconsistent visual content.

Furthermore, in the case of graphical interfaces for display on various devices, the content label system can flexibly customize the display of a content labels on a per-recipient-device basis or per-user basis. To illustrate, the content label system can provide content labels on each collaborating device to facilitate device-specific control of presentation of content labels within a graphical interface. Further, the content label system enables recipient devices to display content labels customized specifically to user accounts, rather than displaying the content labels in a one-size-fits all manner.

As an additional advantage, in one or more embodiments, the content label system provides a more efficient graphical interface than those available in existing systems. Specifically, the content label system can provide consolidated control for generating content labels (e.g., one or more) within a graphical interface through use of the label generation prompt. By introducing this functional improvement to graphical interfaces generating content labels (e.g., one or more), the content label system can reduce the amount of user interactions required to generate and modify content labels. Indeed, as opposed to prior systems that require many inputs for item-by-item interaction to control the creation and modification of content labels, the content label system requires far fewer interactions to control the creation and modification of content labels for use in a graphical interface.

As illustrated by the foregoing discussion, the present disclosure utilizes a variety of terms to describe features and benefits of the content label system. Additional detail is now provided regarding the meaning of these terms. In particular, as used herein the term “content label” refers to a textual and/or graphical element that is presented to the end-user within a software (e.g., mobile or desktop) application, website, or any platform that presents graphical information to users. The content label can include various types of interface elements, such as labels, messages, instructions, notifications, menu items, button texts, error alerts, graphics, icons, and other information. The content label can communicate information, guide user device interactions, provide informational feedback, or convey specific actions that user devices can take within a graphical interface. For example, a content label could include the text “Save As” in combination with an icon of a floppy disk which is displayed on a selectable button on the graphical interface to indicate that clicking the button saves the current selection under a different name. As another example, a content label could include a textual instruction that provides details about graphical content such as a label under an image stating “the x-axis displays age ranges, while the y-axis represents the percentage of engagement.”

Relatedly, as used herein the term “graphical interface” (or “graphical user interface” or “GUI”) refers to a visual display that allows users to interact with electronic devices, software applications, or systems through graphical elements, such as icons, buttons, windows, and menus. A graphical interface replaces the traditional command-line interface with a more intuitive and user-friendly environment. A graphical interface leverages visual representations to present information, facilitate actions, and provide feedback to users. For example, a user device can interact with a content label within a graphical interface by pointing at the content label with a cursor and clicking a mouse button.

As used herein the term “label generation instruction” refers to a set of guidelines or specifications that define textual or visual content for a content label within a graphical interface. The label generation instruction outlines how the content label can be composed, formatted, and positioned to effectively communicate information or guide user device interactions. For example, the label generation instruction can include contextual label data, a set of label generation rules, and a label generation prompt for generating a content label corresponding to an interface element within a graphical interface.

Relatedly, as used herein the term “label generation prompt” refers to an input that includes instructions associated with generating a content label. In particular, a label generation prompt can include a text string that instructs a neural network to generate a content label for a particular interface element and/or for a particular purpose within a graphical interface. For example, the text prompt can be a text string that provides information or suggests actions. To illustrate, the text prompt can include limiters that define parameters for the content label such as “provide a heading having a length of 20 characters or less,” “in German,” or “using formal language”. Relatedly, as used herein, the term “label modification prompt” refers to an input that includes instructions associated with modifying a content label. In particular, a label modification prompt can include a text string that instructs a neural network to modify a content label for a particular interface element or for a particular purpose within a graphical interface.

As used herein the term “contextual label data” refers to information associated with a content label that provides additional context, meaning, or data for generating a content label. In particular, contextual label data can include a description of context where and how a generated label is to be placed within a graphical interface. For example, contextual label data can include coordinate locations (e.g., x and y pixel values), border information, graphical interface element size, content label size, character length, content label category (e.g., button label vs. informational label vs. header label), organization data, and/or user account data. In some cases, certain aspects of contextual label data are derived from a source tree that defines the hierarchy of data and objects in a graphical interface (and/or from an XLM/HTML file).

Further, as used herein the term “label generation rules” refers to guidelines that outline the criteria for creating content labels based on various factors. In particular, label generation rules can include predefined constraints associated with how content labels are created, formatted, and displayed within a graphical interface and/or associated graphical interfaces. In addition, the label generation rules include maintaining consistent terminology and design across a graphical interface (or a set of associated graphical interfaces) to create a seamless and unified user experience. To illustrate, the label generation rules include a cohesive set of rules including size/length constraints, colors to use or not use, preferred phrasing, design requirements, and/or other rules. For example, label generation rules can ensure the content label is consistent across a Dropbox application (e.g., use “save to Dropbox” instead of “upload to Dropbox” in every instance when a file is saved).

As used herein, the term “neural network” refers to one or more machine learning models that can be tuned (e.g., trained) based on inputs to approximate unknown functions. In particular, the term neural network can include a model of interconnected neurons that communicate and learn to approximate complex functions and generate outputs based on a plurality of inputs provided to the model. For instance, the term neural network can include one or more machine learning algorithms. In particular, the term neural network can include deep convolutional or deconvolutional neural networks that include various blocks, layers, components, and/or elements. In addition, a neural network can be an algorithm (or set of algorithms) that implements deep learning techniques that utilize a set of algorithms to model high-level abstractions in data.

As used herein, the term “label generator neural network” refers to a type of artificial neural network utilized by the content label system to automate the process of generating textual or visual labels within a graphical interface, application, or any context where content labels are required. In particular, the label generator neural network can leverage machine learning techniques to learn patterns, styles, and relationships from existing labeled data and then generate new labels that align with the learned characteristics. The predictions made by the label generator neural network can be compared with the actual target values from the training data to determine the discrepancy between the predictions and the ground truth (e.g., the loss). The loss can then be used to compute gradients, which represent the sensitivity of the model's predictions to changes in its parameters (weights and biases). These gradients can be computed using backpropagation, which involves calculating how much each parameter needs to be adjusted to minimize the loss. The label generative neural network can undergo an iterative training process, iterating through multiple training cycles, or epochs. In each epoch, the model can update its parameters using the calculated gradients, gradually improving its performance by minimizing the loss. In some cases, a label generator neural network includes a large language model (e.g., GPT-3) or a vision-language model that process rich content items to generate textual content for the content label.

As used herein, the term “content hierarchy profile” refers to a structured representation that outlines the organization and arrangement of content within a graphical interface, website, application, or any graphical platform that presents information to users. The content hierarchy profile defines the hierarchical relationships between different pieces of content, governing their importance, grouping, and sequence. For example, the content hierarchy profile can be used to implement navigation elements like menus, tabs, buttons, or links that allow users to move between different content areas of the graphical interface as defined in the content hierarchy profile. Furthermore, the content hierarchy profile can be represented in appropriate data structures such as nested arrays, dictionaries, objects, or classes to organize content elements as well as XLM/HTML and CSS for web-based interfaces or UI frameworks for mobile applications.

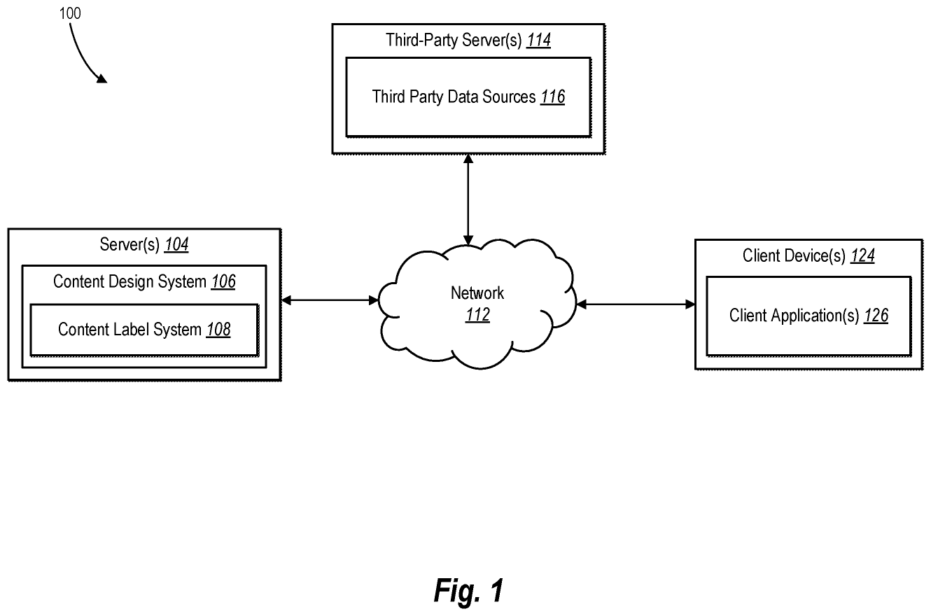

Additional detail regarding the content label system will now be provided with reference to the figures. For example, FIG. 1 illustrates a schematic diagram of an exemplary system environment (“environment”) 100 in which a content label system 108 can be implemented. An overview of the content label system 108 is described in relation to FIG. 1. Thereafter, a more detailed description of the components and the processes of the content label system 108 is provided in relation to the subsequent figures.

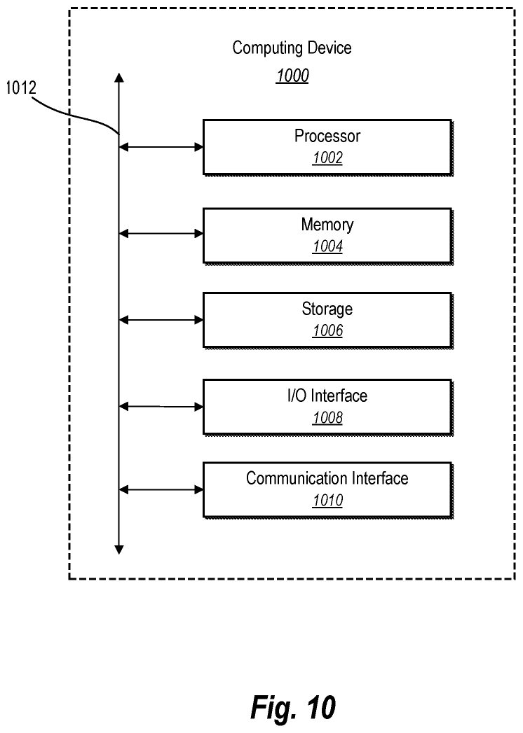

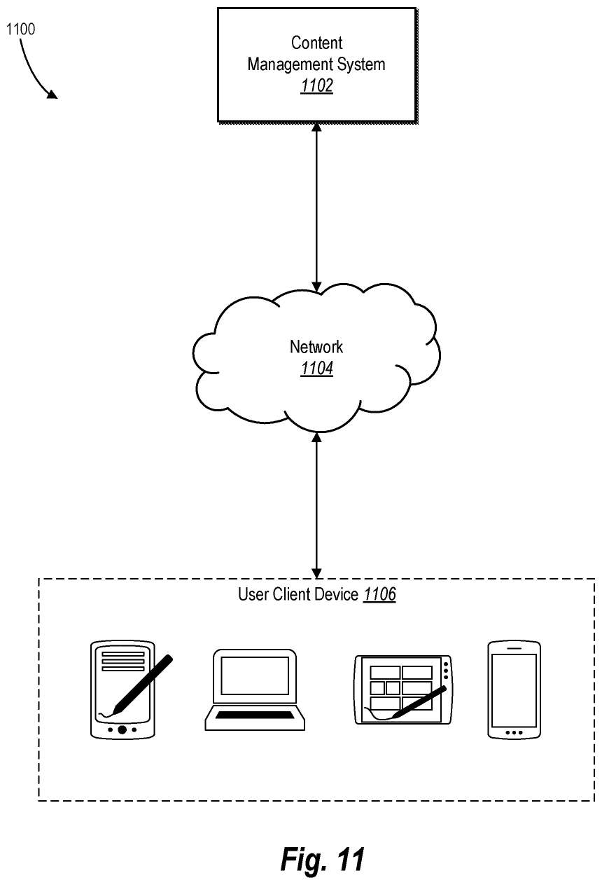

As shown, the environment includes third-party server(s) 114 and client device(s) 124. The client device(s) 124 can be one of a variety of computing devices, including a smartphone, a tablet, a smart television, a desktop computer, a laptop computer, a virtual reality device, an augmented reality device, or another computing device as described in relation to FIGS. 10-11. The client device(s) 124 can communicate with the server(s) 104 and or third-party server(s) 114 via the network 112. For example, the client device(s) 124 can receive user input from respective users interacting with the client device(s) 124 (e.g., via the content design system 106) to, for instance, access, or modify, and/or add or content labels for display (e.g., via the content label system 108). In addition, the content label system 108 on the third-party server(s) 114 can receive information relating to various interactions with content labels and/or graphical interface elements based on the input received by the client device(s) 124 (e.g., to generate content labels for display).

As shown, the client device(s) 124 can include a client application(s) 126. In particular, the client application(s) 126 may be a native application installed on the client device(s) 124 (e.g., a mobile application, a desktop application, etc.), or a cloud-based or web application where all or part of the functionality is performed by the third-party server(s) 114. Based on instructions from the content design system 106, the client device(s) 124 can present or display information, via the client application(s) 126, including graphical interfaces that include content labels.

As illustrated in FIG. 1, the example environment also includes the third-party server(s) 114. The third-party server(s) 114 may generate, track, store, process, receive, and transmit electronic data, such as content labels, interactions with content labels, and/or interactions between user accounts or client devices. For example, the third-party server(s) 114 may receive data from the client device(s) 124 in the form of a request to generate a content labels, interact with a content labels, or display/remove a content labels for a graphical system on the client device(s) 124. Indeed, the third-party server(s) 114 can communicate with the client device(s) 124 to send and/or receive data via the network 112. In some implementations, the third-party server(s) 114 comprise(s) a distributed server where the third-party server(s) 114 include(s) a number of server devices distributed across the network 112 and located in different physical locations. The third-party server(s) 114 can comprise one or more content servers, application servers, communication servers, web-hosting servers, machine learning servers, and other types of servers.

As shown in FIG. 1, the third-party server(s) 114 can also include the content label system 108 as part of a content design system 106. The content design system 106 can communicate with the client device(s) 124 to perform various functions associated with the content design system 106 such as managing content labels and facilitating user interaction with content labels. The content design system 106 can communicate with the third-party server(s) 114 to perform various functions associated with the content label system 108 such as identifying and collecting third-party data for the content labels. Indeed, the content design system 106 can include a network-based cloud storage system to manage, store, and maintain content labels and related data across numerous user accounts.

As shown in FIG. 1, the third-party server(s) 114 can include third party data sources 116. In some embodiments, the content label system 108 and/or the content design system 106 access the third-party server(s) 114 to access and obtain information from third party data sources 116 such as digital content, content labels, graphical interface data, and other information. In some embodiments, the content label system 108 and/or the content design system 106 access the client device(s) 124 to access and obtain information from third party data sources 116 such as digital content, content labels, graphical interface data, and other information.

Although FIG. 1 depicts the content label system 108 located on the server(s) 104, in some implementations, the content label system 108 may be implemented by one or more components of the environment (e.g., located entirely or in part). For example, the content label system 108 may be implemented by the client device(s) 124, and/or the third-party server(s) 114. For example, the client device(s) 124 can download all or part of the content label system 108 for implementation independent of, or together with, the server(s) 104.

In some implementations, though not illustrated in FIG. 1, the environment may have a different arrangement of components and/or may have a different number or set of components altogether. For example, the client device(s) 124 may communicate directly with the content label system 108, bypassing the network 112. As another example, the environment may include multiple client devices, each associated with a different user account for managing digital documents.

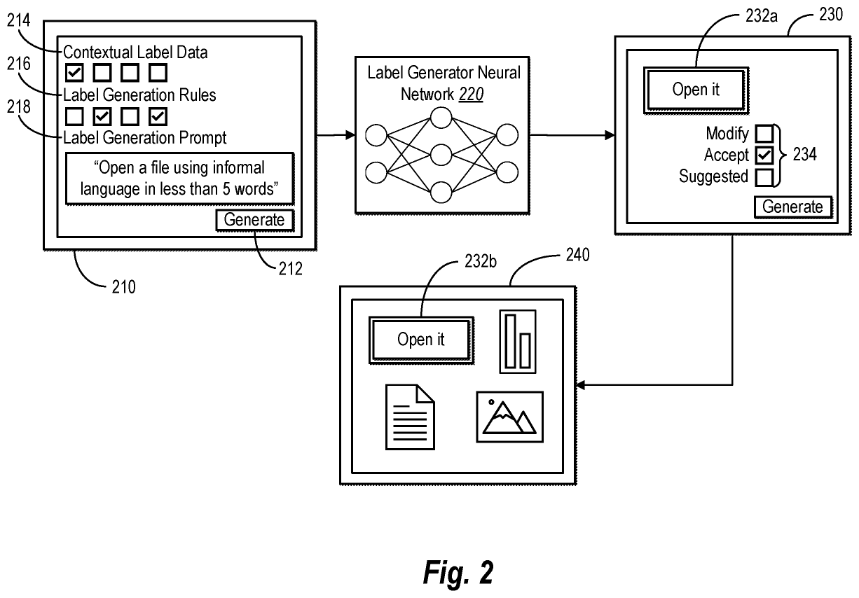

As mentioned above, the content label system 108 can generate content labels that provide information and/or suggest actions. FIG. 2 illustrates an overview of a content label system generating a content label in accordance with one or more embodiments. Additional detail regarding the various parts of FIG. 2 is provided thereafter with reference to subsequent figures.

As illustrated in FIG. 2, the content label system 108 provides a graphical interface 210 to generate a content label. As mentioned, the content label system 108 is trained to generate a label based on an input that includes a label generation instruction. As shown, the graphical interface 210 provides an interface to receive a label generation instruction that includes inputs for contextual label data 214, a set of label generation rules 216, and a label generation prompt 218 for generating the content label corresponding to an interface element. Namely, the contextual label data 214 includes options for positioning, aligning, and incorporating the content label within a graphical interface. For example, by utilizing the contextual label data 214 for one or more content labels, the content label system 108 can provide a responsive design where the content labels and the additional graphical elements adjust to different label constraints based on the purpose of the content labels to improve the serviceability of the labels within graphical interface. In addition, the label generation rules 216 define guidelines for generating labels that include approved and restricted parameters. The content label system 108 utilizes the label generation rules 216 to aid in the creation of a cohesive, functional graphical interface. For example, by creating one or more content labels based on the same label generation rules, the content label system 108 provides consistency in labelling within the graphical interface. As further shown, the label generation prompt 218 includes a natural language text string that indicates the purpose, context, and/or constraints for the content label. As shown, the content label system 108 accepts a generation input 212 to generate a content label based on the selected options for the label generation instruction.

As further illustrated in FIG. 2, the content label system 108 utilizes a label generator neural network 220 to generate the content label based on the label generation prompt. In particular, the content label system 108 utilizes the label generator neural network 220 to generate textual and/or visual labels within a graphical interface, application, or any context where content labels are required. In particular, the label generator neural network 220 leverages machine learning techniques to learn patterns, styles, and relationships from existing labeled data and then generates new content labels that align with the learned characteristics. A label generator neural network 220 can include a machine learning model and/or a natural language processing (NLP) algorithm. In particular, during training, the label generator neural network 220 is presented with input label data and a corresponding output content label. The model then uses techniques to identify patterns in the input label data, such as correlations between certain selections and a likely content label, and the model gradually adjusts its parameters to better predict content labels based on the input. This prediction can be made by using a probabilistic approach, where the model generates a set of possible content labels and selects the most likely content label based on the learned probabilities. In some cases, the label generator neural network 220 includes a large language model (e.g., GPT-3) or a vision-language model to generate textual content for the content labels.

Furthermore, the content label system 108 provides the content label 232a in a graphical interface 230. As shown, the content label system 108 generates the content label 232a based on the contextual label data 214, the set of label generation rules 216, and the label generation prompt 218. For example, the content label 232a can include a preview of the content label as generated by the content label system 108 that incorporates the features specified by the contextual label data 214, label generation rules 216, and label generation prompt 218 such as generated textual content and a graphical interface element. The content label system 108 provides the content label 232a in the graphical interface 230 with options 234 for the user device to accept or modify the generated content label 232a. Based on the selected option of the options 234, the content label system 108 generates the content label.

As also shown, the content label system 108 provides an option to generate additional labels based on the content label 232a (e.g., the “Suggested” selection within options 234). In some embodiments, based on a selection of this option, a prompt or dialog box appears (or other graphical element), suggesting the generation of additional content labels related to the content. For example, based on the user device selection of options 234 to generate an additional label, the content label system 108 can suggest one or more labels related to the content label. For example, based on a pattern of historical content label creation, the content label system 108 can suggest additional content labels that have been linked to (or historically associated with) the generated content label 232a. To illustrate, based on historical patterns, the content label system 108 can suggest one or more additional content labels when generating a content label with text of “Open it” including a content label with the text of “Close it” and a content label with the text of “Ignore it.”

In certain embodiments and based on the user device acceptance of the generated content label, the content label system 108 provides the content label 232b integrated within a graphical interface 240. In particular, based on the user device selection of the options 234 to accept the content label 232a, the content label system 108 integrates the content label 232b into the graphical interface 240. For example, the content label system 108 integrates the content label 232b based on the generated positioning, size, design, color, alignment, content, and other variables in relation to the additional content of the graphical interface 240.

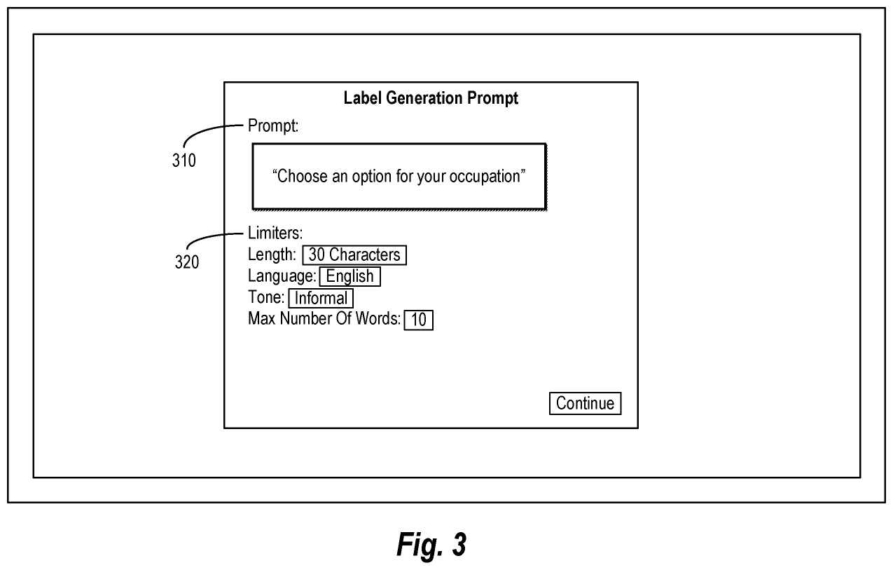

As mentioned, in one or more embodiments, the content label system 108 generates a content label based on a label generation prompt. FIG. 3 illustrates an example graphical interface for providing a label generation prompt in accordance with one or more embodiments.

As illustrated in FIG. 3, the content label system 108 provides a label generation prompt interface 310 to receive text prompt input and selections associated with generating a content label. For example, the label generation prompt interface 310 includes a prompt element that accepts a natural language text string indicating a particular element or purpose for the content label. In particular, the content label system 108 analyzes the natural language text string to identify key words, phrases, and concepts within the text prompt input. For example, the natural language text string can indicate a graphical interface element, and the content label system 108 can identify the graphical interface element to include within the generated content label. Further, the content label system 108 can extract relevant information to determine the context of the label placement in the graphical interface, determine the actionable part of the text that describes what the content label does, determine the purpose for the content label, and/or determine information associated with the appropriate formatting and style for the content label.

In certain embodiments, the content label system 108 determines linguistic patterns, semantics, and relationships present in the text prompt input. For example, the content label system 108 utilizes a neural network to analyze natural language text. As used herein, a “neural network” refers to one or more neural networks utilized by the content label system 108 in various configurations. For example, the content label system 108 can utilize a combination of one or more neural network models that work together to analyze natural language text. To illustrate the content label system 108 can incorporate multiple neural networks in a sequential fashion to improve prediction accuracy and/or a hierarchical fashion for more complex tasks.

To illustrate, the content label system 108 divides the text prompt input into tokens, including words, subwords, or characters. Each token is represented as a vector in a high-dimensional space. The content label system 108 uses embeddings to capture the semantic relationships between words by placing similar words closer together in the vector space (e.g., utilizing Word2Vec, GloVe, and FastText). The content label system 108 feeds the sequence of word embeddings as input into the neural network (e.g., Recurrent Neural Networks (RNNs), Long Short-Term Memory (LSTM) networks, and Gated Recurrent Units (GRUs)). Further, the content label system 108 utilizes attention mechanisms allow the network to focus on different parts of the input text while processing each token. In this way, the content label system 108 captures important contextual information and relationships between words. The content label system 108 trains a neural network using labeled data, where the model's predictions are compared to the actual labels. The content label system 108 utilizes backpropagation and optimization algorithms, such as gradient descent, to adjust the model's parameters to minimize the prediction error.

In certain embodiments, the prompt element can include image inputs. In this case, the content label system 108 provides analogous content labels based on the constraints inherent in the image input. For example, based on an input illustration indicating a finger pushing a button, the content label system 108 provides a content label that includes an illustration of a finger pushing a button that also satisfies the associated contextual label data and label generation rules. As another example, based on an input icon indicating a garbage can, the content label system 108 provides a content label that includes a trashcan image and also satisfies the associated contextual label data and label generation rules.

As further shown in FIG. 3, the content label system 108 utilizes limiters 320 to further refine the label generation prompt. For example, the limiters can include a maximum character count, a minimum character count, a language, or a tone. As another example, the limiters can include specific keywords or phrases that are relevant to the context or function of the content label. The limiters can include a language or tone for the generated content label to ensure it aligns with the overall communication style of the associated graphical interface. The limiters can include guidelines for how the generated label should adapt to different scenarios or user device interactions. The limiters can include a category or type of label that needs to be generated, thus helping the content label system 108 to create labels with specific functions or purposes.

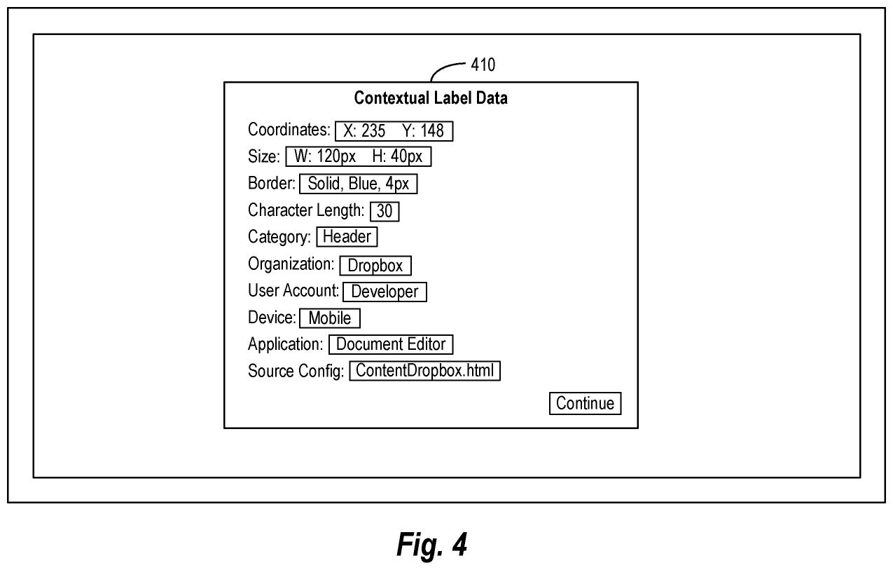

As mentioned, in one or more embodiments, the content label system 108 generates a content label based on a contextual label data. FIG. 4 illustrates an example graphical interface for providing contextual label data to generate a content label in accordance with one or more embodiments.

As illustrated in FIG. 4, the content label system 108 provides a contextual label data interface 410 including information associated with generating a content label. As mentioned, in one or more embodiments, the content label system 108 utilizes contextual label data that includes the context of how and where a label is to be placed within a graphical interface. For example, the contextual label data interface 410 includes one or more contextual label data elements of coordinates, size, border, character length, category, organization, user account, device type (e.g., mobile or desktop), application, and source configuration. For example, the content label system 108 utilizes contextual label data to coordinate label location, determine border configuration of the label, determine a label category within the graphical interface, determine a graphical interface element size, determine a character font, or other context within a graphical interface. For example, the content label system 108 can utilize existing contextual label data (e.g., application or organization specific contextual data) and populate suggestions for the contextual label data interface 410 elements. In some cases, certain aspects of contextual data are derived from a source tree that defines the hierarchy of data and objects in a graphical interface (and/or from an XLM/HTML file).

As mentioned, in certain embodiments, the content label system utilizes a content hierarchy profile defining a structured representation of different content categories associated with content labels for the graphical interface. In particular, based on the hierarchy profile, the content label system 108 categorizes graphical content into different graphical sections, categories, or tiers. For example, in a graphical interface design, the content label system 108 uses categories that include menu structures, navigation bars, breadcrumbs, or other navigational elements. Further, the content label system 108 utilizes the hierarchy profile to break down content into subsections or modules that are related by function or topic and enhance graphical organization and user comprehension. The content label system 108 utilizes the tools of typographic hierarchy to aid in visual grouping of content such as using size, color, contrast, and position, to visually differentiate between content elements based on their importance and relevance. In addition, the content label system 108 integrates accessibility features through the hierarchy profile to ensure that graphical content is accessible and understandable by users with disabilities.

As mentioned, in one or more embodiments, the content label system 108 generates a content label based on a label generation rules. FIG. 4 illustrates an example graphical interface for utilizing label generation rules to generate a content label in accordance with one or more embodiments.

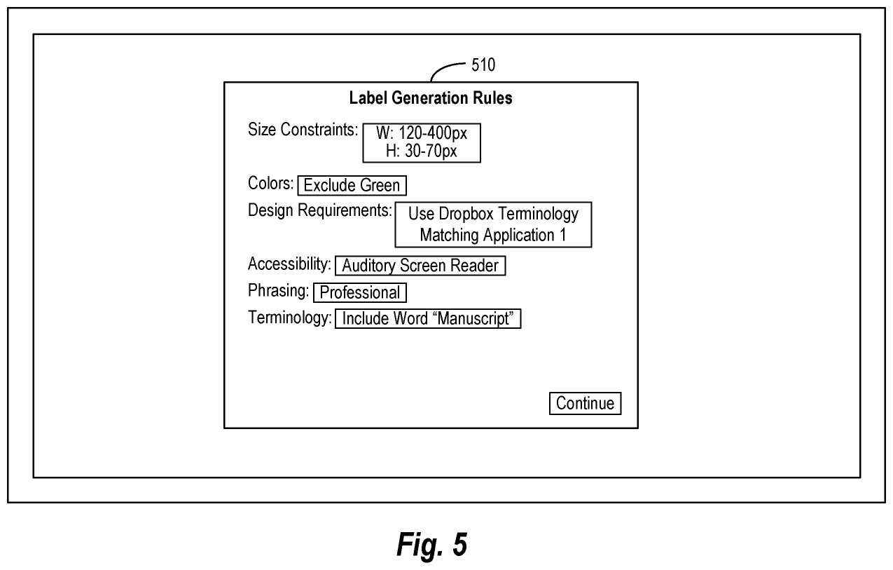

As illustrated in FIG. 5, the content label system 108 provides a label generation rules interface 510 for receiving label generation rules such as parameters and constraints associated with generating a content label. As shown, the content label system 108 can generate rules based, for example, on size, color, design, accessibility, phrasing, and/or terminology constraints. As an example, the content label system 108 generates labels based on rules that incorporate organizational design requirements including branding, user experience, target audience, visual identity, and functional needs.

In certain embodiments, the content label system 108 generates the labels based on constraints associated with predefined rules and variables. In some cases, the content label system 108 incorporates label generation rules that incorporate phrasing constraints including constraints establishing a consistent tone, style, language, and brevity in the generated content label. In this way, the content label system 108 streamlines the process of generating labels for different sections and functionalities within specific graphical systems of the graphical interface for an organization such as based on a requested tone/ambience. For example, label generation rules can include requirements to set a tone chosen from a plurality of tones such as one or more of a formal, friendly, informal, assertive, encouraging, instructive, neutral, crisp, concise, playful, creative, supportive, urgent, or professional tone. For example, the content label system 108 can utilize existing label generation rules (e.g., application or organization specific label generation rules) and populate suggestions for the label generation rules interface 510. In some cases, the content label system 108 generates labels that can be localized for different languages and cultures such as accounting for longer text translations or using symbols that are universally understood.

To illustrate, the content label system 108 utilizes label generation rules for the Dropbox application that include organization-specific constraints. As an example, the label generation rules interface for the Dropbox organization (or application) require the sparse use of certain colors. In particular, the content label system 108 reserves the primary brand color, Dropbox Blue, for specific navigational graphical content such as the tab element, for loading, and for primary actions. Furthermore, the content label system 108 utilizes label generation rules for the Dropbox organization that require using simple, short, plain-spoken, and easy-to-understand statements for content labels. In addition, the label generation rules include requirements for a consistent terminology across associated graphical interfaces. Indeed, through utilizing the label generation rules for the Dropbox organization, the content label system 108 unifies Dropbox designs across platforms and associated graphical interfaces to provide a more consistent user device experience across platforms.

As another example, the content label system 108 utilizes the label generation rules for the internationalization of content labels. For example, in some cases the content label system 108 determines content labels from a prompt containing English words that do not have direct equivalents in another language and the content label system 108 determines content labels that satisfy a specific nuance and/or linguistic context. For example, the content label system 108 utilizes label generation rules that include rules for the use of specific words or visual elements to provide the translation for certain English words/phrases. In this way, the content label system 108 ensures the concepts and significance of the content labels are preserved even if there are not equivalent words in other languages.

As another example, the content label system 108 utilizes the label generation rules to define different profiles based on user device, application, organization, or user role. For example, the label generation rules interface 510 can provide different criteria-driven guidelines based on various label generation rule profiles. For example, the label generation rule profiles can be based on device type (e.g., mobile, desktop), relevant applications (e.g., development, production, end-user), organizational affiliation (e.g., Dropbox), and role within the organization (e.g., end-user, development). Further, the label generation rule profiles can be based on identified user attributes such as end-users, enterprise users, mobile users, accessibility users, advanced users, administrators, sales team, web application users, management team, and/or development team.

As an additional example, the content label system 108 utilizes the label generation rules to define how organizational branding is incorporated for content labels associated with a graphical interface. For example, based on the label generation rules, the content label system 108 includes constraints to ensure that organizational branding (e.g., logos, color palette, slogans, typography) are displayed effectively, maintain integrity, and align with the overall design. For example, the label generation rules can include logo size constraints that include a minimum and maximum size limit that ensures legibility and prevents distortion. The label generation rules can require a specific aspect ratio for logos, an amount of clear space around the logo, a contrast for the logo from the background color, and/or consistent placement of logos across graphical interfaces.

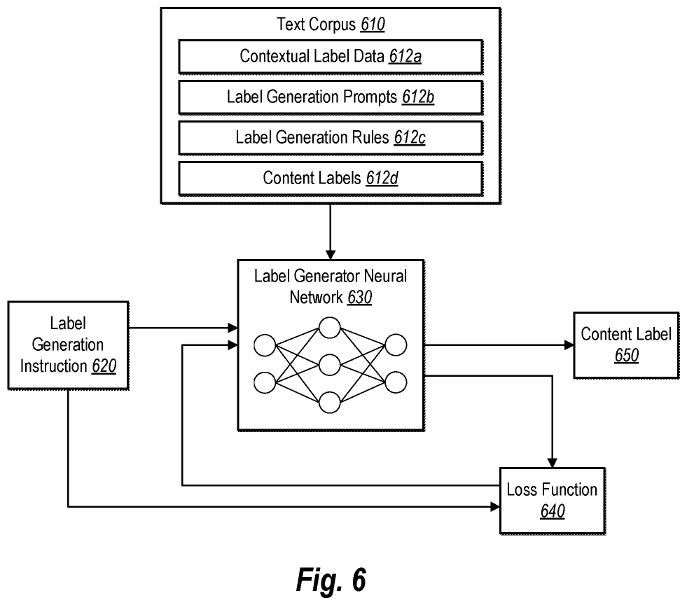

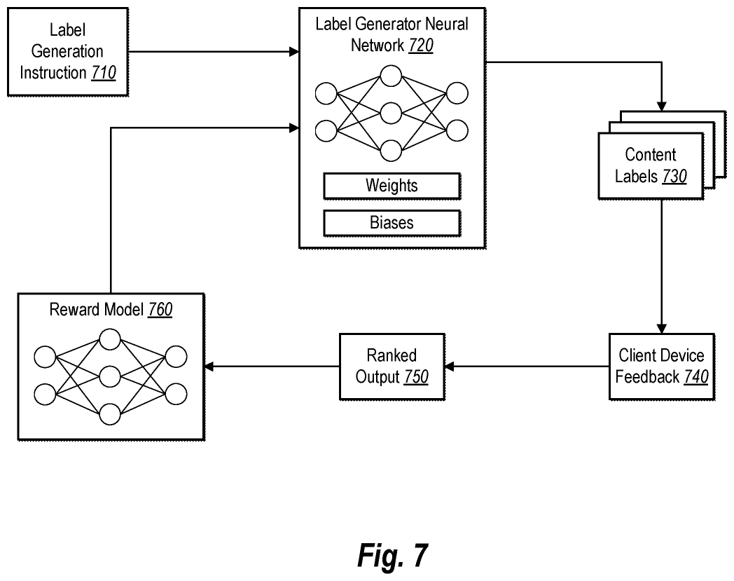

In certain embodiments, the content label system utilizes a neural network to determine the content label from the label generation prompt. FIGS. 6-7 illustrate examples of a content label system training a generator neural network in accordance with one or more embodiments.

As shown in FIG. 6, the content label system 108 trains a label generator neural network 630 based on a text corpus 610 to provide a content label 650. As shown, the label generator neural network 630 is trained utilizing the text corpus 610 which includes example contextual label data 612a, label generation prompts 612b, label generation rules 612c, and content labels 612d. For example, the text corpus 610 includes contextual label data 612a such as the context where a generated label is to be placed, coordinate locations, border information, element size, label size, character length, or label category. In some cases, contextual data is derived from a source tree that defines the contextual relationships based on existing applications or environments. As shown, the text corpus 610 includes label generation prompts 612b such as historical label generation prompts associated with the content labels 612d. For example, the label generation prompts 612b include text strings that define a particular purpose or particular interface element for the associated content labels 612d. As further shown, the text corpus 610 includes label generation rules 612c such as a list (or other format) of rules that define parameters for generating the associated content labels 612d. For example, the label generation rules 612c include the “dos” and “don'ts” for the associated content labels 612d including size/length preferences and constraints, colors to use or not use, phrasing preferences or exclusions, and/or design preferences or exclusions. As shown, the text corpus 610 includes content labels 612d such as content labels 612d associated with the contextual label data 612a, label generation prompts 612b, and label generation rules 612c.

In particular, the label generator neural network 630 includes a model of interconnected neurons that communicate and learn to approximate complex functions and the generate content label 650 based on a plurality of inputs (e.g., text corpus 610) provided to the model. In particular, the label generator neural network 630 leverages machine learning techniques to learn patterns, styles, and relationships from existing labeled data and then generates new labels that align with the learned characteristics. Indeed, the label generator neural network 630 uses historical training data to learn patterns and relationships within the training data. The label generator neural network 630 further utilizes a measure of loss between training data and the content label to quantify the difference or error (e.g., loss) between the predictions and the actual desired outputs (e.g., content labels) from the historical training data. The label generator neural network 630 minimizes this loss (utilizing the loss function 640), which signifies the gap between predicted values and true labels, thus improving the label generator neural network 630 accuracy and performance over time. As mentioned, the label generator neural network 630 can include a deep convolutional or a deconvolutional neural network that include various blocks, layers, components, and/or elements.

As mentioned, the label generator neural network 630 generates predictions for content labels from a label generation instruction 620. The predictions made by the label generator neural network 630 are compared with the actual target values (e.g., content labels 612d) from the text corpus 610 to determine the discrepancy between the predictions and the ground truth (e.g., the loss function 640). The loss function 640 is then used to compute gradients, which represent the sensitivity of the model's predictions to changes in its parameters (utilizing weights and biases). These gradients are computed using backpropagation, which involves calculating how much each parameter needs to be adjusted to minimize the loss. As shown, the training process for the label generative neural network is iterative. The label generator neural network goes through multiple epochs, each consisting of many batches of data. In each epoch, the model updates its parameters using the calculated gradients, gradually improving its performance by minimizing the loss. By training the neural network 630 on a specific corpus of training data (e.g., only labels generated and approved for an organization and/or an application) the model learns to produce labels corresponding to the requirements, styles, dimensions of that organization and/or application.

As shown in FIG. 7, the content label system 108 can further train the label generator neural network 720 utilizing a reward model 760 and reinforcement learning. For example, the label generator neural network 720 generates a set of content labels 730 based on the label generation instruction 710 and a set of initial weights and biases. As mentioned, the label generation instruction includes information associated with the generation of a content label (e.g., contextual label data, set of label generation rules, and label generation prompt). The set of content labels 730 includes a set of options for content labels that vary from each other and yet attempt to satisfy the requirements of the label generation instruction 710. As also shown, the label generator neural network 720 incorporates client device feedback 740 during training to generate a ranked output 750. For example, client device feedback 740 can be based on the coherence, relevance to prompt, readability, fluency, variety, accuracy, diversity, contextual consistency, and/or usability of the content labels 730.

In particular, the ranked output is generated by selecting one or more of the set of content labels 730 that most closely satisfies the requirements of the label generation instruction 710. As shown, the label generator neural network 720 utilizes the reward model 760 to calculate reward value that includes a loss based on the ranked output 750 and the content labels 730. The training process is iterative. As shown, the content label system 108 utilizes a refined learning algorithm generate the content labels 730 using backpropagation through the label generator neural network 720 to update its weights and biases using optimization algorithms (e.g., stochastic gradient descent or Adam). For example, the content label system 108 utilizes reinforcement learning to enable the label generator neural network to learn from its own actions (e.g., content label generation) and modify its behavior accordingly rather than depending on pre-existing labeled data (e.g., as with supervised learning models). To illustrate, the label generator neural network 720 can be a large language model that is fine-tuned based on client device feedback 740 that takes into account the result of options for previous content labels 730 and modifies its behavior as a result.

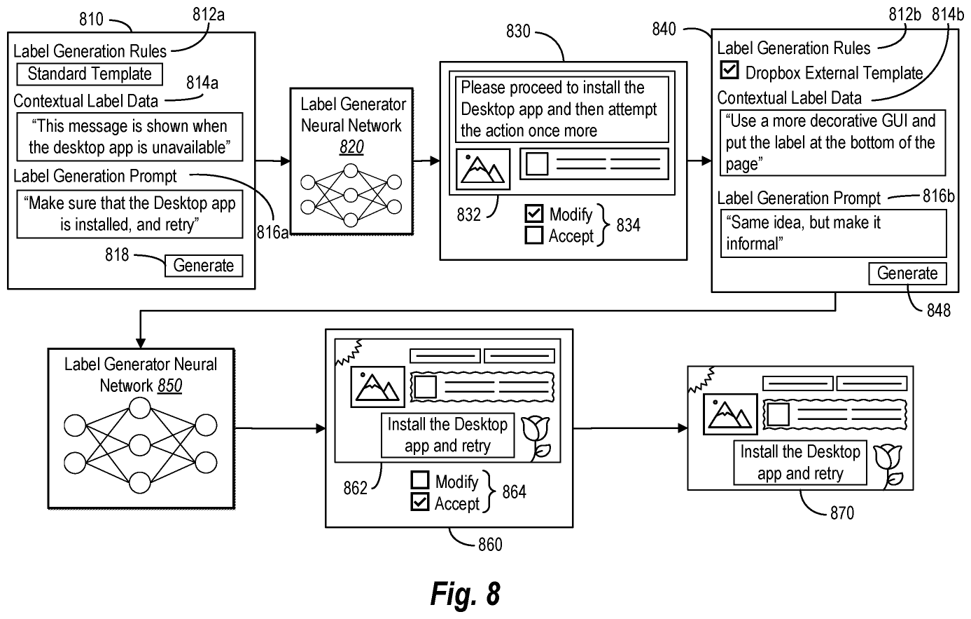

As mentioned, the content label system 108 provides options for modifying content labels. FIG. 8 illustrates an example of a content label system modifying a label for a graphical interface in accordance with one or more embodiments.

As shown, the content label system 108 provides a graphical interface 810 that incorporates a label generation instruction including label generation rules 812a, contextual label data 814a, and label generation prompt 816a for generating a content label corresponding to an interface element of a graphical interface. As mentioned, the content label system 108 utilizes the label generation rules 812a to implement consistent and cohesive content labels within the graphical interface and/or associated graphical interfaces. In addition, the contextual label data 814a provides context for generating the content label including information and actions associated with the intended purpose of the content label. Further, the label generation prompt 818 includes a natural language text string further indicating the purpose, context, and constraints for the content label that the content label system 108 utilizes when generating the content label. As shown, the content label system 108 accepts a label generation prompt 818 to generate a content label based on the provided information.

As further illustrated in FIG. 8, the content label system 108 utilizes a label generator neural network 820 to generate the content label based on the label generation instruction. In particular, the content label system 108 utilizes the label generator neural network 820 to automate the process of generating textual and/or visual labels within a graphical interface, application, or any context where content labels are required. As mentioned, the label generator neural network 820 leverages machine learning techniques to learn patterns, styles, and relationships from existing labeled data and then generates content labels that align with the learned characteristics.

In certain implementations, the content label system 108 provides a preview 832 of the content label in the context of an application (e.g., GUI or website) within a graphical interface 830. In some implementations, the content label system 108 provides the preview 832 as an overlay wherein the content label system 108 provides a design interface wherein when a user device hovers or clicks on a label field, an overlay appears on the graphical interface, displaying the content label and styling within the actual context of the graphical interface. In some implementations, when the user device interacts with a label element, the content label system 108 provides the preview 832 as a tooltip or popup window containing a preview of the label, allowing the designer to assess the content label. In some embodiments, the content label system 108 provides the preview 832 as a split-screen interface that displays the label editor on one side and a graphical interface on the other side that provides a view of the content label changes on the interface design in real-time. In some implementations, the content label system 108 provides the preview 832 as a button or switch that toggles between the normal design mode and a preview mode, showing how the content label will look when integrated into the graphical interface. In some implementations, the content label system 108 provides the preview 832 as a drag-and-drop functionality where the user device can drag and drop the content label onto various graphical elements, simulating how the content label will appear when placed on different parts of the graphical interface. In some implementations, the content label system 108 provides the preview 832 as a selection of graphical interface templates for the user device to select from, thereby providing a view of how the content label integrates within pre-designed content. As shown, the content label system 108 provides options 834 to modify or accept the content label based on the preview 832.

As shown, the content label system 108 provides a graphical interface 840 to modify the content label. In particular, based on the selection from the options 834 to modify the content item, the content label system 108 provides the graphical interface 840 that includes a label modification prompt. For example, the content label system 108 provides a label modification prompt that includes inputs to modify one or more label generation rules 812b, contextual label data 814b, and a label generation prompt 816b for generating a content label corresponding to an interface element of a graphical interface. As shown, the content label system 108 accepts a generation input 848 to generate a content label based on the modification information.

As further illustrated in FIG. 8, the content label system 108 utilizes a label generator neural network 850 to generate the modified content label based on the label modification prompt. In particular, the content label system 108 utilizes the label generator neural network 850 to automate the process of modifying textual and/or visual labels within a graphical interface, application, or any context where content labels are required. As mentioned, the label generator neural network 850 leverages machine learning techniques to learn patterns, styles, and relationships from existing labeled data and then generates modified content labels that align with the learned characteristics. In certain embodiments, the content label system 108 utilizes the same label generator neural network 820 for the label generator neural network 850.

As further shown, the content label system 108 provides a preview 862 of the content label in the context of an application (e.g., GUI or website) within a graphical interface 860. As shown, the content label system 108 incorporates the modifications to the content label and/or modifications to the associated application within the preview 862. Similar to the discussion regarding the preview 832, the content label system 108 can provide the preview 862 in a multitude of ways including but not limited to a website preview, an overlay preview, a popup preview, a split-screen preview, a toggle preview, a drag-and-drop preview, and/or a template preview. As shown, the content label system 108 provides options 864 to modify or accept the content label based on the preview 862.

As shown, the content label system 108 provides the content label for integration within a modified graphical interface 870. In particular, based on the selection from the options 864 to accept the modified content item, the content label system 108 provides the graphical interface 870 that includes the modified content item.

Notably, the content label system 108 can be used to efficiently modify one or more existing content labels. For example, the content label system 108 can modify one or more content labels based on updates to contextual label data, one or more label generation rules, label modification prompts. To illustrate, the content label system 108 can utilize label generation rules that include organization-specific constraints to efficiently update organization-wide content label constraints. As example, the content label system 108 can implement a modification to content labels associated with all (or a subset) of the Dropbox organization graphical interfaces to change instances of header content items to include a “Happy Birthday Dropbox” textual string. In this way, the content label system 108 can quickly and easily update label content (and associated label content) to satisfy dynamic changes associated with graphical interfaces for an entire organization (or subset of an organization). As another example, the content label system 108 can implement a modification to content labels associated with all (or a subset) Dropbox applications to implement a consistent terminology across all (or a subset) associated graphical interfaces (e.g., using “Save to Dropbox” instead of “Download to Dropbox” for all associated graphical interfaces).

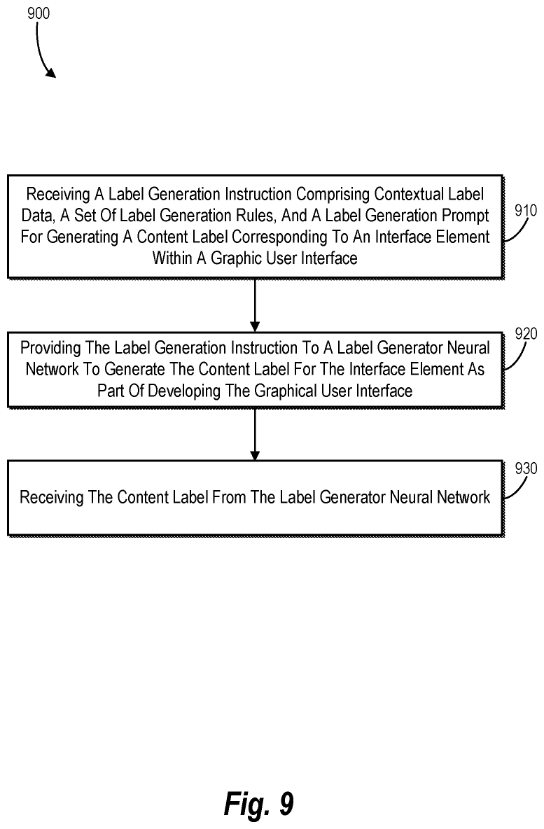

FIGS. 1-8, the corresponding text, and the examples provide a number of different systems and methods for generating and providing content labels based on label generation instructions. In addition to the foregoing, implementations can also be described in terms of flowcharts comprising acts/steps in a method for accomplishing a particular result. For example, FIG. 9 illustrates an example series of acts for generating and providing a content label based on a label generation instruction.

As illustrated in FIG. 9, the series of acts 900 may include an act 910 of receiving a label generation instruction comprising contextual label data, a set of label generation rules, and a label generation prompt for generating a content label corresponding to an interface element within a graphical interface. For example, in one or more embodiments, the act 910 can include receiving, from a client device, a label generation instruction comprising contextual label data, a set of label generation rules, and a label generation prompt for generating a content label corresponding to an interface element within a graphical interface. In addition, the series of acts 900 includes an act 920 of providing the label generation instruction to a label generator neural network to generate the content label for the interface element as part of developing the graphical interface. For example, in one or more embodiments, the act 920 can include providing the label generation instruction to a label generator neural network to generate the content label for the interface element as part of developing the graphical interface according to the contextual label data, the set of label generation rules, and the label generation prompt. As further illustrated in FIG. 9, the series of acts 900 includes an act 930 of receiving the content label from the label generator neural network. In one or more embodiments, as described above, the act 930 can include based on the user interaction, removing the one or more rich content items from display within the digital document on the client device.

Further, in one or more embodiments, the series of acts 900 includes receiving, from the client device, a label modification prompt comprising an update to at least one of the contextual label data, the set of label generation rules, or the label generation prompt. In addition, in one or more embodiments, the series of acts 900 includes providing, to the label generator neural network, an updated label generation instruction comprising the update to the at least one of the contextual label data, the set of label generation rules, or the label generation prompt. Furthermore, in one or more embodiments, the series of acts 900 includes receiving, at the client device, a modified content label from the label generator neural network.

Additionally, in one or more embodiments, the series of acts 900 includes receiving contextual label data comprising context information for the content label comprising one or more of a coordinate location within a graphical interface, a border configuration of the graphical interface, a label category within the graphical interface, a graphical interface element size, or a character font. Moreover, in one or more embodiments, the series of acts 900 includes receiving contextual label data comprising a content hierarchy profile, the content hierarchy profile defining a structured representation of different content categories associated with content labels for the graphical interface and the label generation prompt comprises a content category from the content hierarchy profile. Further, in one or more embodiments, the series of acts 900 includes receiving label generation rules comprising parameters for one or more of label size constraints, label placement constraints, label color constraints, or label phrasing constraints for the content label. Furthermore, in one or more embodiments, the series of acts 900 includes receiving label generation rules comprising design requirements indicating a plurality of tones associated with content labels for the graphical interface.

Moreover, in one or more embodiments, the series of acts 900 includes receiving a label generation prompt comprising a selected tone from the plurality of tones that is associated with a visual presentation of the graphical interface for an organization. Additionally, in one or more embodiments, the series of acts 900 includes receiving a label generation prompt comprising a natural language text string indicating a purpose for the content label. Moreover, in one or more embodiments, the series of acts 900 includes receiving a label generation prompt comprising a natural language text string indicating a graphical interface element and receiving the content label comprises receiving a preview of the content label shown in combination with the graphical interface element. In addition, in one or more embodiments, the series of acts 900 includes receiving a label generation instruction comprising contextual label data, a set of label generation rules, and a label generation prompt for generating a content label corresponding to an interface element within a graphical interface.

Additionally, in one or more embodiments, the series of acts 900 includes generating, utilizing a label generator neural network, the content label for the interface element based on the contextual label data, the set of label generation rules, and the label generation prompt. Furthermore, in one or more embodiments, the series of acts 900 includes providing the content label for presentation within a graphical interface. Moreover, in one or more embodiments, the series of acts 900 includes receiving a label modification instruction comprising a label modification prompt for modifying the content label.

In addition, in one or more embodiments, the series of acts 900 includes generating, utilizing a label generator neural network, a modified content label. Furthermore, in one or more embodiments, the series of acts 900 includes providing the modified content label for presentation within the graphical interface. Moreover, in one or more embodiments, the series of acts 900 includes generating, utilizing the label generator neural network, the content label based on historical training data and utilizing a measure of loss between training data and the content label. Additionally, in one or more embodiments, the series of acts 900 includes receiving a contextual label data comprising design requirements for a mobile device.

Further, in one or more embodiments, the series of acts 900 includes receiving a label generation prompt comprising a natural language text string indicating a graphical interface element and receiving the content label comprises receiving a preview of the content label incorporating the graphical interface element. Moreover, in one or more embodiments, the series of acts 900 includes generating an additional content label based on the content label and historical content label generation requests and providing the additional content label for presentation within the graphical interface.

Additionally, in one or more embodiments, the series of acts 900 includes receiving, from a client device, a label generation instruction comprising contextual label data, a set of label generation rules, and a label generation prompt for generating a content label corresponding to an interface element within a graphical interface. Further, in one or more embodiments, the series of acts 900 includes providing the label generation instruction to a label generator neural network to generate the content label for the interface element according to the contextual label data, the set of label generation rules, and the label generation prompt. Moreover, in one or more embodiments, the series of acts 900 includes receiving, at the client device, the content label from the label generator neural network for display on a graphical interface. In addition, in one or more embodiments, the series of acts 900 includes receiving a label modification instruction comprising a label modification prompt for modifying the content label.

Moreover, in one or more embodiments, the series of acts 900 includes generating, utilizing a label generator neural network, a modified content label. In addition, in one or more embodiments, the series of acts 900 includes providing the modified content label from the label generator neural network for display on the graphical interface. Additionally, in one or more embodiments, the series of acts 900 includes receiving the set of label generation rules comprising label phrasing constraints that define parameters for language used in the content label. Moreover, in one or more embodiments, the series of acts 900 includes receiving contextual label data comprising a content hierarchy profile, the content hierarchy profile defining a structured representation of different content categories associated with content labels for the graphical interface. Further, in one or more embodiments, the series of acts 900 includes receiving the label generation prompt comprising a content category from the content hierarchy profile.

In one or more implementations, each of the components of the content label system 108 are in communication with one another using any suitable communication technologies. Additionally, the components of the content label system 108 can be in communication with one or more other devices including one or more client devices described above. It will be recognized that in as much the content label system 108 is shown to be separate in the above description, any of the subcomponents may be combined into fewer components, such as into a single component, or divided into more components as may serve a particular implementation.

FIG. 10 illustrates a block diagram of exemplary computing device 1000 that may be configured to perform one or more of the processes described above. The components of the content label system 108 can include software, hardware, or both. For example, the components of the content label system 108 can include one or more instructions stored on a computer-readable storage medium and executable by processors of one or more computing devices (e.g., the computing device 1000). When executed by the one or more processors, the computer-executable instructions of the content label system 108 can cause the computing device 1000 to perform the methods described herein. Alternatively, the components of the content label system 108 can comprise hardware, such as a special purpose processing device to perform a certain function or group of functions. Additionally, or alternatively, the components of the content label system 108 can include a combination of computer-executable instructions and hardware.

Furthermore, the components of the content label system 108 performing the functions described herein may, for example, be implemented as part of a stand-alone application, as a module of an application, as a plug-in for applications including content management applications, as a library function or functions that may be called by other applications, and/or as a cloud-computing model. Thus, the components of the content label system 108 may be implemented as part of a stand-alone application on a personal computing device or a mobile device.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

As mentioned, FIG. 10 illustrates a block diagram of exemplary computing device 1000 that may be configured to perform one or more of the processes described above. One will appreciate that third-party server(s) 114, the client device(s) 124, and/or the computing device 1000 may comprise one or more computing devices such as computing device 1000. As shown by FIG. 10, computing device 1000 can comprise processor 1002, memory 1004, a storage device, a I/O interface, and communication interface 1010, which may be communicatively coupled by way of communication infrastructure 1012. While an exemplary computing device 1000 is shown in FIG. 10, the components illustrated in FIG. 10 are not intended to be limiting. Additional or alternative components may be used in other implementations. Furthermore, in certain implementations, computing device 1000 can include fewer components than those shown in FIG. 10. Components of computing device 1000 shown in FIG. 10 will now be described in additional detail.

In particular implementations, processor 1002 includes hardware for executing instructions, such as those making up a computer program. As an example, and not by way of limitation, to execute instructions, processor 1002 may retrieve (or fetch) the instructions from an internal register, an internal cache, memory 1004, or storage device 1006 and decode and execute them. In particular implementations, processor 1002 may include one or more internal caches for data, instructions, or addresses. As an example, and not by way of limitation, processor 1002 may include one or more instruction caches, one or more data caches, and one or more translation lookaside buffers (TLBs). Instructions in the instruction caches may be copies of instructions in memory 1004 or storage device 1006.

Memory 1004 may be used for storing data, metadata, and programs for execution by the processor(s). Memory 1004 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. Memory 1004 may be internal or distributed memory.

Storage device 1006 includes storage for storing data or instructions. As an example, and not by way of limitation, storage device 1006 can comprise a non-transitory storage medium described above. Storage device 1006 may include a hard disk drive (HDD), a floppy disk drive, flash memory, an optical disc, a magneto-optical disc, magnetic tape, or a Universal Serial Bus (USB) drive or a combination of two or more of these. Storage device 1006 may include removable or non-removable (or fixed) media, where appropriate. Storage device 1006 may be internal or external to computing device 1000. In particular implementations, storage device 1006 is non-volatile, solid-state memory. In other implementations, Storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1008 allows a user to provide input to, receive output from, and otherwise transfer data to and receive data from computing device 1000. I/O interface 1008 may include a mouse, a keypad or a keyboard, a touch screen, a camera, an optical scanner, network interface, modem, other known I/O devices or a combination of such I/O interfaces. I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1008 is configured to provide graphical data to a display for presentation to a user. The graphical data may be representative of one or more graphical interfaces and/or any other graphical content as may serve a particular implementation.

Communication interface 1010 can include hardware, software, or both. In any event, communication interface 1010 can provide one or more interfaces for communication (such as, for example, packet-based communication) between computing device 1000 and one or more other computing devices or networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1010 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1010 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1012 may include hardware, software, or both that couples components of computing device 1000 to each other. As an example and not by way of limitation, communication infrastructure 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 11 is a schematic diagram illustrating environment 1100 within which one or more implementations of the content label system 108 can be implemented. As discussed above with respect to FIG. 1, in some embodiments the content label system can be part of a content management system. In such cases, the content label system can perform various functions a content management system performs, as described below. The content management system 1102 may generate, store, manage, receive, and send digital content (such as digital videos). For example, content management system 1102 may send and receive digital content to and from the user client device 1106 by way of network 1104. In particular, the content management system 1102 can store and manage a collection of digital content. The content management system 1102 can manage the sharing of digital content between computing devices associated with a plurality of users. For instance, the content management system 1102 can facilitate a user sharing a digital content with another user of content management system 1102.

In particular, the content management system 1102 can manage synchronizing digital content across multiple user client devices 1106 associated with one or more users. For example, a user may edit digital content using user client device 1106. The content management system 1102 can cause user client device 1106 to send the edited digital content to content management system 1102. Content management system 1102 then synchronizes the edited digital content on one or more additional computing devices.

In addition to synchronizing digital content across multiple devices, one or more implementations of content management system 1102 can provide an efficient storage option for users that have large collections of digital content. For example, content management system 1102 can store a collection of digital content on content management system 1102, while the user client device 1106 only stores reduced-sized versions of the digital content. A user can navigate and browse the reduced-sized versions (e.g., a thumbnail of a digital image) of the digital content on user client device 1106. In particular, one way in which a user can experience digital content is to browse the reduced-sized versions of the digital content on user client device 1106.

Another way in which a user can experience digital content is to select a reduced-size version of digital content to request the full-or high-resolution version of digital content from content management system 1102. In particular, upon a user selecting a reduced-sized version of digital content, user client device 1106 sends a request to content management system 1102 requesting the digital content associated with the reduced-sized version of the digital content. Content management system 1102 can respond to the request by sending the digital content to user client device 1106. User client device 1106, upon receiving the digital content, can then present the digital content to the user. In this way, a user can have access to large collections of digital content while minimizing the amount of resources used on user client device 1106.

User client device 1106 may be a desktop computer, a laptop computer, a tablet computer, a personal digital assistant (PDA), an in-or out-of-car navigation system, a handheld device, a smart phone or other cellular or mobile phone, or a mobile gaming device, other mobile device, or other suitable computing devices. User client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1104.

Network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which user client devices 1106 may access content management system 1102.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
receiving, from a client device, a label generation instruction comprising contextual label data, a set of label generation rules, and a label generation prompt for generating a content label corresponding to an interface element within a graphical interface;
providing the label generation instruction to a label generator neural network to generate the content label for the interface element according to the contextual label data, the set of label generation rules, and the label generation prompt; and
receiving, at the client device, the content label from the label generator neural network.

2. The method of claim 1, further comprising:
receiving, from the client device, a label modification prompt comprising an update to at least one of the contextual label data, the set of label generation rules, or the label generation prompt;
providing, to the label generator neural network, an updated label generation instruction comprising the update to at least one of the contextual label data, the set of label generation rules, or the label generation prompt; and
receiving, at the client device, a modified content label from the label generator neural network.

3. The method of claim 1, wherein the contextual label data comprises context information for the content label comprising one or more of a coordinate location within a graphical interface, a border configuration of the graphical interface, a label category within the graphical interface, a graphical interface element size, or a character font.

4. The method of claim 1, wherein:
the contextual label data comprises a content hierarchy profile, the content hierarchy profile defining a structured representation of different content categories associated with content labels for the graphical interface; and
the label generation prompt comprises a content category from the content hierarchy profile.

5. The method of claim 1, wherein the set of label generation rules comprise parameters for one or more of label size constraints, label placement constraints, label color constraints, or label phrasing constraints for the content label.

6. The method of claim 1, wherein the set of label generation rules comprise design requirements indicating a plurality of tones associated with content labels for the graphical interface.

7. The method of claim 6, wherein the label generation prompt comprises a selected tone from the plurality of tones that is associated with a visual presentation of the graphical interface for an organization.

8. The method of claim 1, wherein the label generation prompt comprises a natural language text string indicating a purpose for the content label.

9. The method of claim 1, wherein:
the label generation prompt comprises a natural language text string indicating a graphical interface element; and
receiving the content label comprises receiving a preview of the content label shown in combination with the graphical interface element.

10. A system comprising:
a memory component; and
one or more processing devices coupled to the memory component, the one or more processing devices to perform operations comprising:
receiving a label generation instruction comprising contextual label data, a set of label generation rules, and a label generation prompt for generating a content label corresponding to an interface element within a graphical interface;
generating, utilizing a label generator neural network, the content label for the interface element based on the contextual label data, the set of label generation rules, and the label generation prompt; and
providing the content label for presentation within a graphical interface.

11. The system of claim 10, further comprising:
receiving a label modification instruction comprising a label modification prompt for modifying the content label;
generating, utilizing a label generator neural network, a modified content label; and
providing the modified content label for presentation within the graphical interface.

12. The system of claim 10, further comprising generating, utilizing the label generator neural network, the content label based on historical training data and utilizing a measure of loss between the historical training data and the content label.

13. The system of claim 10, wherein the contextual label data comprises design requirements for a mobile device.

14. The system of claim 10, wherein:
the label generation prompt comprises a natural language text string indicating a graphical interface element; and
receiving the content label comprises receiving a preview of the content label incorporating the graphical interface element.

15. The system of claim 10, further comprising:
generating an additional content label based on the content label and historical content label generation requests; and
providing the additional content label for presentation within the graphical interface.

16. A non-transitory computer readable medium comprising instructions that, when executed by at least one processor, cause a computing device to:
receive, from a client device, a label generation instruction comprising contextual label data, a set of label generation rules, and a label generation prompt for generating a content label corresponding to an interface element within a graphical interface;
provide the label generation instruction to a label generator neural network to generate the content label for the interface element according to the contextual label data, the set of label generation rules, and the label generation prompt; and
receive, at the client device, the content label from the label generator neural network for display on a graphical interface.

17. The non-transitory computer readable medium of claim 16, further comprising instructions that, when executed by the at least one processor, cause the computing device to:
receive a label modification instruction comprising a label modification prompt for modifying the content label;
generate, utilizing a label generator neural network, a modified content label; and
provide the modified content label from the label generator neural network for display on the graphical interface.

18. The non-transitory computer readable medium of claim 16, wherein the set of label generation rules comprise label phrasing constraints that define parameters for language used in the content label.

19. The non-transitory computer readable medium of claim 16, wherein the contextual label data comprises a content hierarchy profile, the content hierarchy profile defining a structured representation of different content categories associated with content labels for the graphical interface.

20. The non-transitory computer readable medium of claim 19, wherein the label generation prompt comprises a content category from the content hierarchy profile.
